(19) United States
(12) Patent Application Publication
(10) Pub. No.: US 2021/0094731 A1
(43) Pub. Date: Apr. 1, 2021

(54) COLLAPSIBLE LOGISTICS BOX WITH PORTABILITY

(71) Applicant: Goldtek Technology Co., Ltd., New Taipei City (TW)

(72) Inventors: WU-HUNG YANG, New Taipei (TW); SHIAN-WEN SHIU, New Taipei (TW)

(21) Appl. No.: 16/721,759

(22) Filed: Dec. 19, 2019

(30) Foreign Application Priority Data
Sep. 30, 2019 (TW) 108135401

(51) Int. Cl. B65D 25/28; B65D 6/16; E05G 1/024; E05G 1/00

(52) U.S. Cl. CPC B65D 25/28; E05G 1/005; E05G 1/024; B65D 9/12

(57) ABSTRACT

A strong, durable, and more portable logistics box is capable of being assembled to form a three-dimensional box shape on rollers to store and transport items and being flattened for storage. The logistics box includes walls and locking devices including a first locking device and a second locking device. The walls include a bottom wall and a plurality of sidewalls. The sidewalls include a first sidewall, a last sidewall, and at least one middle sidewall rotatably connected between the first sidewall and the last sidewall. The first locking device is disposed between the first sidewall and the last sidewall and detachably connects the first sidewall to the last sidewall. The bottom wall is rotatably connected to one of the sidewalls. The second locking device is disposed between the bottom wall and another one of the sidewalls and detachably connects the bottom wall to the another one of the sidewalls.

### FIELD

The subject matter herein generally relates to logistics boxes.

### BACKGROUND

Logistics boxes are containers in transporting items. At present, the logistics boxes are mainly cardboard boxes. However, due to inherent characteristics, the cardboard boxes generally have insufficient impact resistance, and their bottoms easily rupture when loaded with heavy items. Furthermore, there are no handholds or mobility or other labor saving structure on the cardboard boxes for facilitating manual moving of the cardboard boxes, which makes the cardboard boxes loaded with heavy objects very hard to move.

Therefore, there is room for improvement.

### BRIEF DESCRIPTION OF THE DRAWINGS

Implementations of the present technology will now be described, by way of embodiments, with reference to the attached figures.

FIG. 1 is a perspective view of a logistics box according to an embodiment of the present disclosure.

FIG. 2 is a perspective view of the logistics box of FIG. 1 from another angle.

FIG. 3 is a perspective view showing another state of the logistics box of FIG. 1.

FIG. 4 shows one side of the logistics box of FIG. 1 after being disassembled and unfolded.

FIG. 5 shows an opposite side of the logistics box of FIG. 4.

FIG. 6 is a perspective view of a locking structure of a locking device of the logistics box of FIG. 1.

FIG. 7 is a cross-sectional view of the locking device of FIG. 6, showing the locked locking device of the logistics box of FIG. 1.

FIG. 8 is a cross-sectional view of the locking device of FIG. 6, showing the unlocked locking device of the logistic box of FIG. 1.

### DETAILED DESCRIPTION

The present disclosure is made in conjunction with the accompanying drawings. Specific embodiments of the present disclosure are described.

In the following description, when an element is described as being “fixed to” another element, the element can be fixed to the another element with or without intermediate elements. When an element is described as “connecting” another element, the element can be connected to the other element with or without intermediate elements. The term “connected” or “connecting” as used in the specification and claims of the present invention is not limited to physical or mechanical connections, whether direct or indirect. For convenience of description, the terms “upper”, “lower”, “front”, “back”, “left”, “right”, and etc. are only used to indicate the relative positional relationships between objects. When the absolute position of a described object is changed, the relative positional relationships between the object and other objects are correspondingly changed.

Without a given definition otherwise, all terms used have the same meaning as commonly understood by those skilled in the art. The term “and/or” means including any and all combinations of one or more of associated listed items.

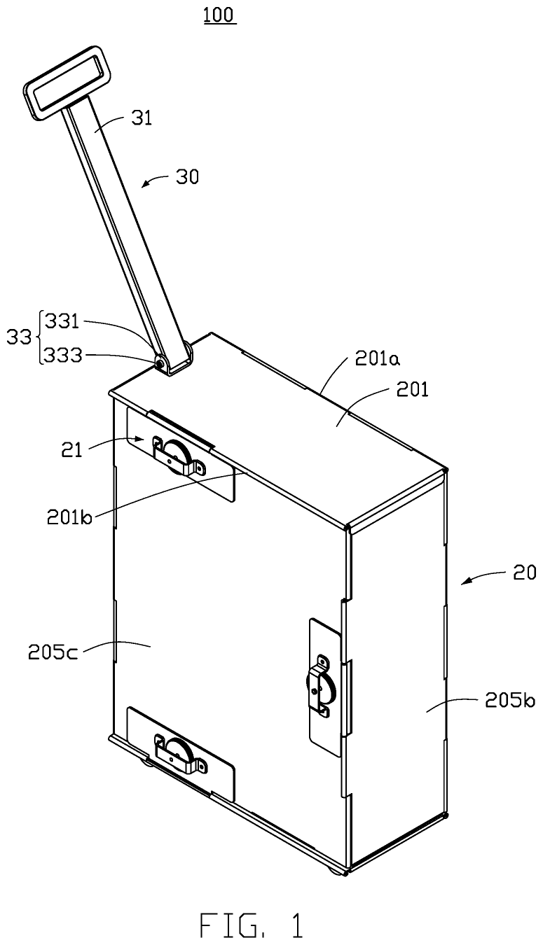

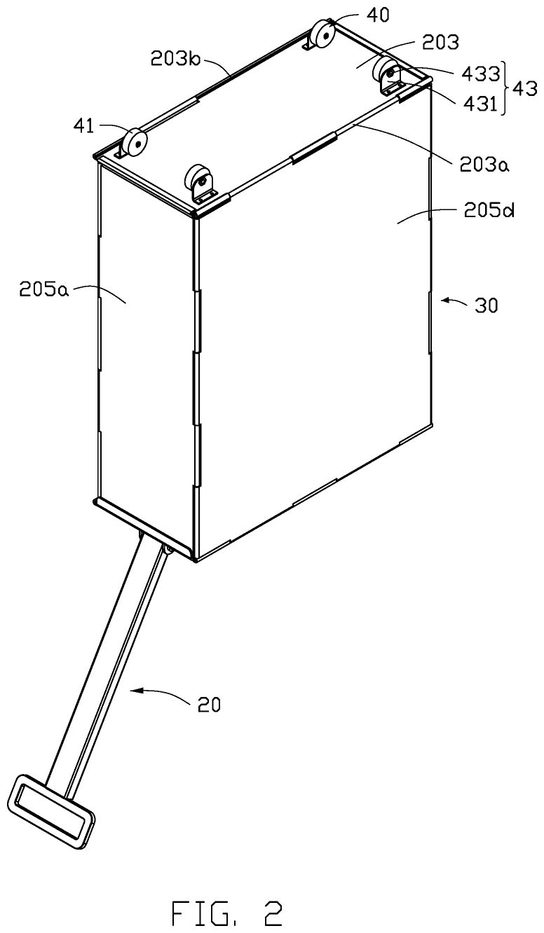

FIGS. 1 and 2 are isometric views of a logistics box according to an embodiment of the present disclosure. The logistics box 100 includes a main body 20, a push-pull device 30, and a plurality of rolling devices 40. In this embodiment, the main body 20 is in a six-sided rectangular parallelepipedic structure and has a top wall 201, a. bottom wall 203, a front wall 205a, a back wall 205b, a left wall 205c, and a right wall 205d. The front wall 205a, the back wall 205b, the left wall 205c and the tight wall 205d are sidewalls connected between the top wall 201 and the bottom wall 203. The front wall 205a is opposite to the back wall 205b, and. the left wall 205c is opposite to the right wall 205d. The main body 20 is made of a hard and. non-deformable material such as a metal material or an alloy material. In one example, the main body is made of iron or aluminum. The push-pull device 30 is fixed to one wall of the main body 20, and the rolling devices 40 are disposed on another wall of the main body 20. In this embodiment, the push-pull device 30 is disposed on the top wall 201 of the main body 20. The push-pull device 30 includes a handle 31 and a connecting device 33 that connects the handle 31 to the top wall 201. In this embodiment, the handle 31 is rotatably coupled to the top wall 201 by the connecting device 33. The connecting device 33 includes a mounting member 331 and a connecting member 333. The mounting member 331 is mounted on the top wall 201 by a conventional way such as screwing or welding, and the connecting member 333 is a hinge disposed on the mounting member 331. The handle 31 is hinged to the top wall 201 by the connecting device 33. The handle 31 can be rotated about the hinge, thereby the handle 31 can be folded to the top wall 201 during storage of the logistic box 100 or unfolded for a user to push or pull during use of the logistic box 100.

In other embodiments, the handle 31 can be fixedly coupled to the top wall 201 rather than being movably coupled to the top wall 201. The push-pull device 30 can be disposed on any one of the other walls of the main body 20 except the bottom wall 203. 100181 In this embodiment_{;} the rolling devices 40 are disposed on the bottom wall 203 of the main body 20, and each of the rolling devices 40 includes a roller 41 and a connecting device 43 connecting the roller 41 to the bottom wall 203. The connecting device 43 includes a mounting member 431 and a connecting member 433. The mounting member 431 is mounted on the bottom wall 203 by a conventional way such as screwing or welding. The connecting member 433 is a hinge that hinges the roller 41 to the mounting member 431, so that the roller 41 can be rolled around the hinge and improve portability of the logistics box 100. In other embodiments, the rolling devices 40 can be disposed on other walls adjacent o the bottom wall 203, only that the rolling devices 40 extend downward beyond the bottom wall 203. in this embodiment, the number of the rolling devices 40 is four, and the four rolling devices 40 are disposed at four corners of the bottom wall 203 respectively. in other embodiments, the number and position of the rolling devices 40 can be changed according to actual needs.

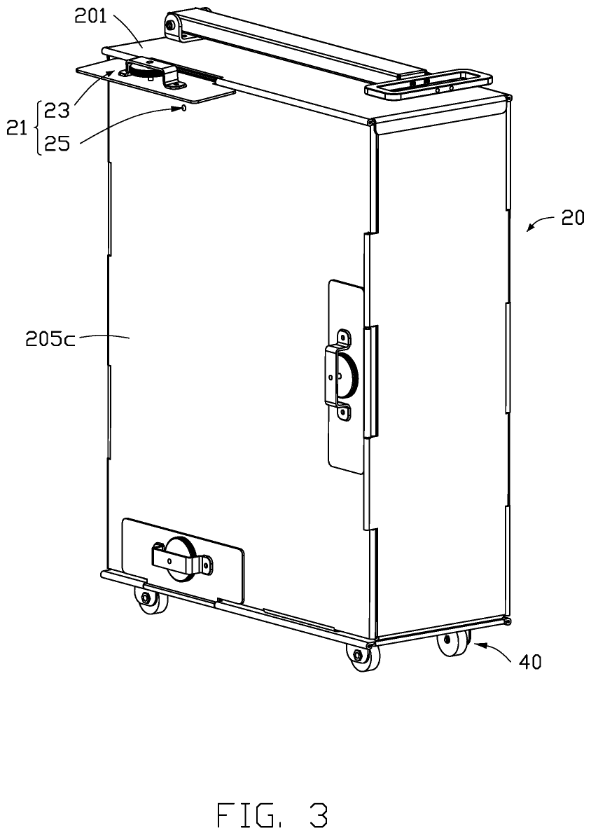

The main body 20 includes a plurality of locking devices 21 for locking a plurality of walls together, thereby the logistic box 100 is assembled for storing and transporting items. Each of the locking devices 21 includes a locking structure 23 disposed on one wall and a mating structure 25 disposed on another wall, The locking structure 23 is engaged with the mating structure 25, thereby locking they two walls together, In this embodiment, there are three locking devices 21 equipped on the main body 20. The left wall 205c, the front wall 205a, the right wall 205d, and the back wall 205b are sequentially connected in a rotatable manner. One side 205e of the back wall 205b is rotatably coupled to one side of the right wall 205d and an opposite side 205f of the back wall 205b carries one of the locking structures 23. The locking structure 23 disposed on the opposite side 205f of the back wall 205b can be moved or rotated to engage with one of the mating structures 25 disposed on the left wall 205c, thereby locking the back wall 205b to the left wall 205c. One side 201a of the top wall 201 is rotatably coupled to one of the sidewalls. In this embodiment, the side 201a of the top wall 201 is rotatably coupled to the right wall 205d. One of the locking structures 23 is disposed on an opposite side 20 lb of the top wall 201. Referring to FIG. 3, the locking structure 23 disposed on the opposite side 201b of the top wall 201 can be moved or rotated to engage with one of the mating structures 25 disposed on the left wall 205c, thereby locking the top wall 201 to the left wall 205c. One side 203a of the bottom 203 is rotatably connected to one of the sidewalk. In this embodiment, the side 203a of the bottom wall 203 is rotatably connected to the right wall 205d. One of the locking structure, 23 is disposed on an opposite side 203b of the bottom wall 203. The locking structure 23 disposed on the opposite side 203b of the bottom wall 203 can be moved or rotated to engage with one of the mating structures 25 disposed on the left wall 205c, thereby locking the bottom wall 203 to the left wall 205c. After the top wall 201, the bottom wall 203, and the back wall 205b are all locked to the left wall 205c, the logistics box 100 can protect the items therein from being damaged during transporting. When one of the three locking devices 21 is unlocked, one of the top wall 201, the bottom wall 203, and the back wall 205b can be opened, thereby the items in the logistics box 100 can be taken out or other items can be loaded into the logistics box 100.

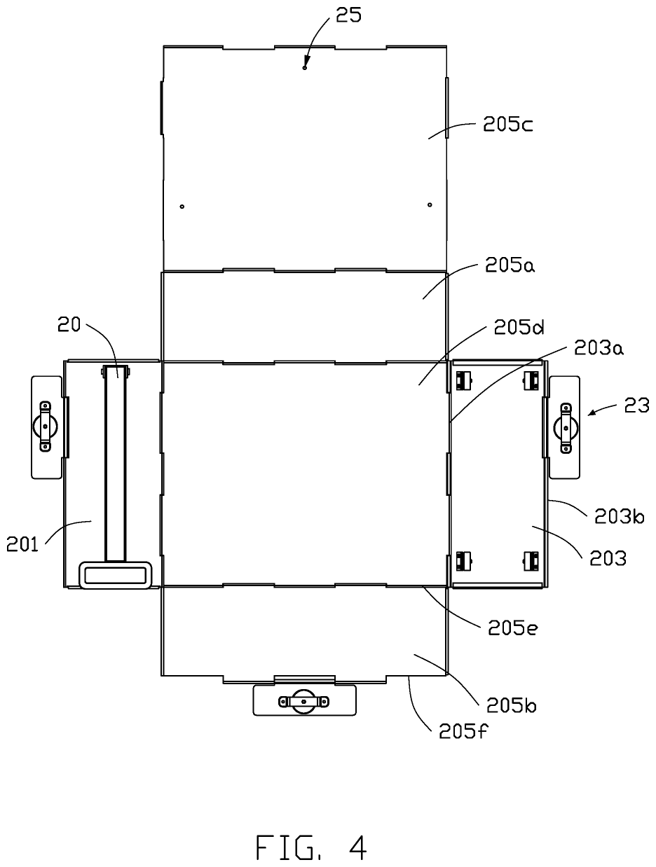

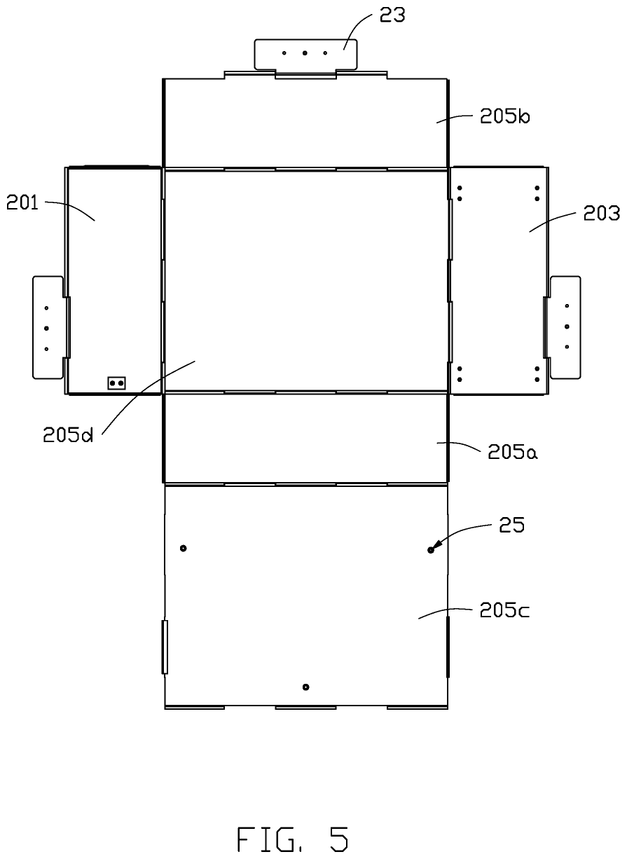

Referring to FIG. 4 and FIG. 5, when the three locking devices 21 are all unlocked, the logistics box 100 can be flattened to facilitate storage of the logistic box 100.

As can be seen from FIG. 4 and FIG. 5, in this embodiment, the front wall 205a is hinged to the left wall 205c, the right wall 205d is hinged to the frontall 205a, the back wall 205b is hinged to the right wall 205d, and the top wall 201 and the bottom wall 203 are both hinged to the right wall 205d. The total six walls can be rotated to form a hexahedron for receiving items or be flattened for facilitating the storage of the logistic box 100. In another alternative embodiment, the six walls can be connected in other ways. For example, the six walls can be connected by soft materials such as rubber and leather that can be folded and bent. A piece of soft material can be used and stapled or otherwise secured to every two adjacent walls of the six walls.

In this embodiment, the three locking structures 23 are disposed on and hinged to edges of the back wall 205b, the top wall 201, and the bottom wall 203 respectively. The locking structures 23 are rotatable about, the corresponding edges to be in contact with the left wall 205c. The mating structures 25 are disposed on the left wall 205c corresponding to the locking structures 23. The mating structures 25 lock the locking structures 23 to the left wall 205c with the back wall 205b, the top wall 201, and the bottom wall 203. In the embodiment, the mating structures 25 are screwed holes defined in the left wall 205c. Each screwed hole corresponds to one of the three locking structures 23.

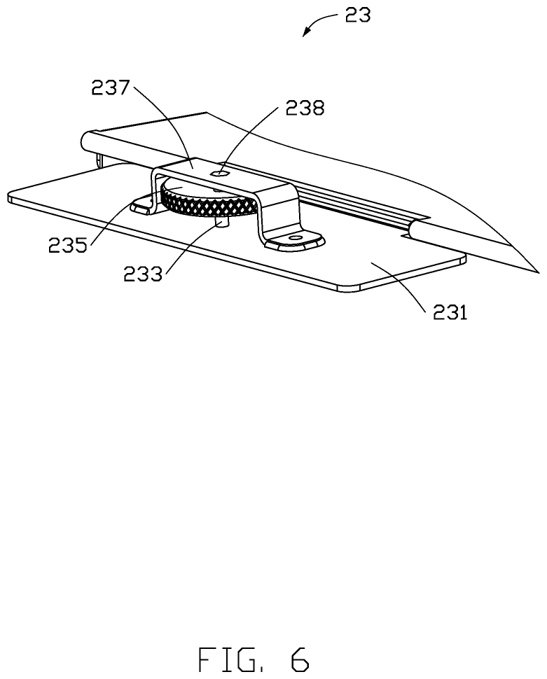

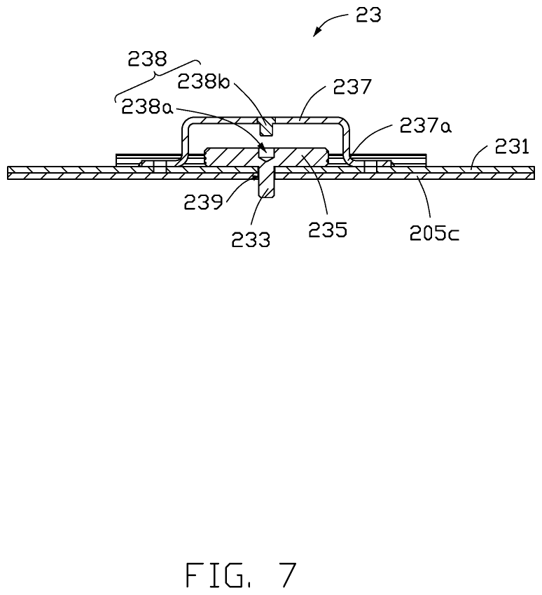

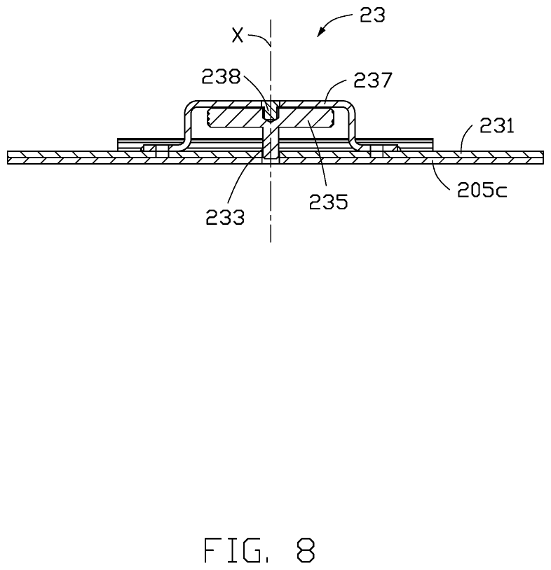

Referring to FIG. 6 to FIG. 8, in this embodiment, each of the three locking structures 23 includes a body 231, a screw 233 screwed on the body 231, a dialing member 235 connecting with the screw 233, and a stopper 237 preventing the screw 233 from being separated from the body 231. In this embodiment, the body 231 is a plate. One side edge of the body 231 is hinged to one wall of the main body 20. A screwed hole 239 is defined on the body 231 and penetrates through the body 231. The screw 233 is received in the screwed hole 239 and engaged with the screwed hole 239. The dialing member 235 is disposed at one end of the screw 233. Another end of the screw 233 passes through the screwed hole 239 and is engaged with the corresponding mating structure 25 disposed on the left wall 205c. The dialing member 235 is operated by a user to rotate the screw 233 such that the screw 233 is engaged with the corresponding mating structure 25 or is disengaged from the corresponding mating structure 25. In this embodiment, the dialing member 235 is a disc disposed coaxially with the screw 233. A diameter of the dialing member 235 is larger than a diameter of the screw 233. The dialing member 235 not only facilitates the user to rotate the screw 233, but also prevents the screw 233 from sinking or passing bodily through the screwed hole 239. In other embodiments, the dialing member 235 can be in other shape, such as a rod-shape, a Y-shape, a ring shape, and the like.

The stopper 237 is disposed above the dialing member 235 and fixed to the body 231 by at least one support leg 237a. The stopper 237 defines an upward moving limit for the dialing member 235. When the screw 233 is rotated upwardly by the dialing member 235 to be disengaged from the corresponding mating structure 25 and the dialing member 235 reaches the upward moving limit, the stopper 237 resists against the dialing member 235 and inhibits the dialing member 235 from moving further, thereby preventing the screw 233 from being over-rotated and separating from the screwed hole 239 Furthermore, in this embodiment, a positioning structure 238 is disposed between the stopper 237 and the dialing member 235. The positioning structure 238 is configured to position the dialing member 235 when the dialing member 235 moves upward to a certain position, and to prevent the dialing member 235 and the screw 233 from being separated from the body 231 during an impact for example. In this embodiment, the positioning structure 238 includes a positioning hole 238a defined on one side of the dialing member 235 facing the stopper 237, and a positioning protrusion 238b disposed on the stopper 237 corresponding to the positioning hole 238a. When the dialing member 235 is moved upward to certain position, the positioning protrusion 238b protrudes into the positioning hole 238a to realize the positioning of the dialing member 235. The positioning structure 238 is disposed axially corresponding to a. rotation axis X of the dialing member 235 or parallel to the rotation axis X. In other embodiments, the positions of the positioning hole 238a and the positioning protrusion 238b are interchangeable. A locking pair is formed between the positioning hole 238a and the positioning protrusion 238b. For example, both the positioning hole 238a and the positioning protrusion 238b are threaded and engaged and lock with each other when the positioning protrusion 238b protrudes in the positioning hole 238a.

In other embodiments, the positioning protrusion 238b is detachably disposed on the stopper 237. For example, a screwed hole is defined on the stopper 237, and the positioning protrusion 238b is threaded to engage with the screwed hole, thereby the positioning protrusion 238b is detachably disposed on the stopper 237 by screwing the positioning protrusion 238b in the screwed hole.

In this embodiment, each of the three locking structures 23 includes a screw 233 and each of the corresponding mating structures 25 includes a screwed hole. Each of the three locking structures 23 and each of the corresponding mating structure 25 are screwed together to lock the hack wall 205b, the top wall 201, and the bottom wall 203 to the left wall 205c, In other embodiments, at least one of the three locking structures 23 includes a hook, and at least one of the corresponding mating structures 25 include a buckle engageable with the hook to lock one wall to another wall.

In this embodiment, the three locking structures 23 are disposed on the back wall 205b, the top wall 201. and the bottom wall 203 respectively, and the corresponding mating structures 25 are disposed on the left wall 205c. However, in other embodiments, the position of the locking structures 23 and the position of the corresponding mating structures 25 are interchangeable.

In this embodiment, one side 201a of the top wall 201 is rotatably connected to the right wall 205d, and the opposite side 201b of the top wall 201 carries one of the three locking structures 23 to detachably lock the top wall 201 to the left wall 205c. One side 203a of the bottom wall 203 is rotatably connected to the right wall 205d, and the opposite side 203b of the bottom wall 203 carries another one of the three locking structures 23 to detachably lock the bottom wall 203 to the left wall 205c. However in other embodiments, the top wall 201 is rotatably connected to the front wall 205a on one side, and detachably locked to the back wall 205b on the opposite side by one of the locking structures 23, or, the top wall 201 is rotatably connected to the back wall 205b on one side, and detachably locked to the front wall 205a on the opposite side by one of the locking structures 23. Similarly, the bottom wall 203 can be rotatably connected to one of the front wall 205a and the back wall 205b on one side, and detachably locked to the other one of the front wall 205a and the back wall 205b on the opposite side by another one of the locking structure 23. In summary, after the six walls of the logistics box 100 are fixed to form the hexahedron, the locking devices 21 may be located on a same wall (such as on the left side wall 205c), or may be distributed on different walls.

In this embodiment, the three locking devices 21 are provided to lock the logistics box 100 into the form of a solid hexahedron. In other embodiments, more than three locking devices 21 can be provided, for example, beside one of the three locking devices 21 locking the top wall 201 to the left wall 205c, there is an additional locking devices 21 locking the top wall 201 to the front wall 205a or to the back wall 205b, and/or there is an additional locking device 21 locking the bottom wall 203 to the front wall 205a or to the back wall 205b. Alternatively, after the top wall 201 is rotatably connected to the right wall 205d, the top wall 201 is locked to both the front wall 205a and the back wall 205b by two of the locking devices 21 while not being locked to the left wall 205c by the locking device 21. Similarly, after the bottom wall 203 is rotatably connected to the right wall 205d, the bottom wall 203 is locked to both the front wall 205a and the back wall 205b by another two of the locking devices 21 while not being locked to the left wall 205c by the locking device 21.

In this embodiment, the logistics box 100 is a hexahedron. In other embodiments, the logistics box 100 can be in other shapes, and the number of the locking devices 21 can be provided according to a shape of the logistics box 100. For example, in another embodiment, the logistic box 100 is a pentahedron having a triangular cross section vertical to the sidewalk, or is a heptahedron having a pentagonal cross section vertical to the sidewalls.

In this embodiment, the logistics box 100 includes the top wall 201. However, in another embodiment, the top wall 201 can be omitted. The logistics box 100 can be an. open-top box. In addition, one or more other walls can be omitted too according to actual needs, such as removing one of the sidewalls.

In summary, the logistics box provided by the present disclosure includes a plurality of walls and a plurality of locking devices. The walls include at least a bottom wall (or a top wall) and a plurality of sidewalls, and the locking devices include at least a first locking device and a second locking device. The sidewalls include a first sidewall (such as the left wall 205c), a last sidewall (such as the back side 205b), and at least one middle sidewall (such as the front wall 205a and the right wall 205d) connected between the first sidewall and the last sidewall in a rotatable manner. The first locking device is disposed between the first sidewall and the last sidewall to detachably connect the first sidewall and the last sidewall. The bottom wall (or the top wall) is rotatably connected to one of the sidewalls (such as the right wall 205d). The second locking device is disposed between the bottom wall (or the top wall) and another one of the sidewalls to detachably connect the bottom wall (or the top wall) to the sidewall. The logistics box provided by the present disclosure can be disassembled and flattened for storage when not in use, thereby saving a storage space. The hard and non-deformable material such as metal used by the logistics box is more suitable for carrying heavy items. The walls are replaceable if holed or buckled, which makes the maintenance of the logistics box more convenient. The stoppers is used to prevent the loss of the locking devices.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A logistics box comprising a plurality of walls and a plurality of locking devices, the plurality of walls comprising a plurality of sidewalls and a bottom wall, the plurality of locking devices comprising at least a first locking device and a second locking device, the plurality of sidewalls comprising a first sidewall, a last sidewall and at least one middle sidewall rotatably connected between the first sidewall and the last sidewall, wherein the first locking device is disposed between the first sidewall and the last sidewall and detachably connects the first sidewall and the last sidewall, the bottom wall is rotatably connected to one of the sidewalls, and the second locking device is disposed between the bottom wall and another one of the sidewalls and detachably connects the bottom wall to the another one of the sidewalls.

2. The logistics box of claim 1, wherein the logistics box is assembled to be a three-dimensional box shape when the first locking device locks the first sidewall to the last sidewall and the second locking device locks the bottom wall to the another one of the sidewalls; and the logistics box is flattened to a plate shape when the first lock device and the second lock device are both unlocked.

3. The logistics box of claim 1, wherein the plurality of walls further comprises a top wall rotatably connected to one of the sidewalls, the plurality of locking devices further comprises a third locking device disposed between the top wall and another one of the sidewalls and detachably connecting the top wall to the another one of the sidewalls.

4. The logistics box of claim 1, wherein the at least one middle sidewall comprises a plurality of middle sidewalls rotatably connected in sequence.

5. The logistic box of claim 1, wherein the plurality of walls are made of metal or alloy.

6. The logistic box of claim 1, wherein the at least one middle sidewall is hinged to the first sidewall and the last sidewall, the bottom wall is hinged to the one of the sidewalls.

7. The logistic box of claim 1, wherein the at least one middle sidewall is rotatably connected to the first sidewall by a piece of bendable soft material, and rotatably connected to the last sidewall by another piece of the bendable soft material, the bottom wall is rotatably connected to the one of the sidewalls by a third piece of the bendable soft material.

8. The logistic box of claim 3, wherein the top wall is hinged to the one of the sidewalls or is rotatably connected to the one of the sidewalls by a piece of bendable soft material.

9. The logistic box of claim 4, wherein the plurality of middle sidewalls are hinged or connected by pieces of bendable soft material.

10. The logistics box of claim 1, wherein each of the locking device comprises a locking structure and a mating structure detachably connected with the locking structure, the locking structure is disposed on one of two walls of the walls, and the mating structure is disposed on another one of the two walls of the walls.

11. The logistics box of claim 10, wherein the locking structure comprises a body, a screw disposed on the body, and a dialing member disposed on the screw, a screwed hole is defined on the body and penetrates through the body, the screw is screwed in the screwed hole, the dialing member is configured to rotate the screw, the mating structure comprises another screwed hole, the screw is driven by the dialing member to engage with the another screwed hole or be disengaged from the another screwed hole, thereby locking or unlocking the two walls.

12. The logistics box of claim 11, wherein the locking structure further comprises a stopper located above the dialing member and fixed to the body by a support leg, the stopper is configured to resist the dialing member to prevent the screw from disengaging from the body when the dialing member is rotated to move the screw up and out of the mating structure.

13. The logistics box of claim 12, wherein a positioning structure is further disposed between the stopper and the dialing member, and the positioning structure comprises a positioning protrusion on one of the stopper and the dialing member and a positioning hole on another one of the stopper and the dialing member, a positioning protrusion is configured to protrude into the positioning hole to position the dialing member when the dialing member is moved upward to a presetposition.

14. The logistics box of claim 13, wherein the positioning structure is disposed axially corresponding to a rotation axis of the dialing member or parallel to the rotation axis.

15. The logistics box of claim 1, wherein the logistics box further comprises a push-pull device disposed on one of the plurality of walls for auxiliary pushing or pulling the logistics box.

16. The logistics box of claim 1, wherein the logistics box further comprises a plurality of rolling devices disposed on the bottom wall or other walls adjacent to the bottom wall, the rolling devices are configured to being rolling to move the logistics box.
